(19) United States
(12) Patent Application Publication
(10) Pub. No.: US 2018/0089869 A1
(43) Pub. Date: Mar. 29, 2018

(54) System and Method For Previewing Indoor Views Using Augmented Reality

(71) Applicant: International Business Machines Corporation, Armonk, NY (US)

(72) Inventors: James Edward Bostick, Cedar Park, TX (US); John Michael Ganci, Cary, NC (US); Martin Geoffrey Keen, Cary, NC (US); Sarbajit Kumar Rakshit, Kolkata (IN); Craig Matthew Trim, Glendale, CA (US)

(21) Appl. No.: 15/278,410

(22) Filed: Sep. 28, 2016

(51) Int. Cl. G06T 11/60; G06K 9/32; G06K 9/62; G02B 27/01; G06F 17/30

(52) U.S. Cl. CPC G06T 11/60; G06K 9/3241; G06K 9/6202; G02B 27/0172; G06F 17/30867; G02B 2027/0141; G06F 17/30256; G06F 17/30268; G02B 2027/014; G02B 2027/0138; G06F 17/3087

(57) ABSTRACT

A method for displaying an indoor view of a building is provided. The method includes the steps of: (i) capturing, with a camera coupled to a pair of augmented reality glasses, at least one image; (ii) identifying, within the image, an identifying marker; (iii) determining from the identifying marker a search parameter; (iv) determining a location of the glasses or a mobile device paired with the glasses; (v) entering the search parameter into a search engine; (vi) receiving from the search engine the location of at least one building; (vii) selecting the building having the location nearest to the geolocation of the glasses or the mobile device; (viii) retrieving from an indoor view repository an indoor view of the selected building; and (ix) displaying at least a portion of the retrieved indoor view over a portion of the user's field of view when wearing the glasses.

### BACKGROUND

The present invention is directed to methods and systems for previewing indoor views of buildings using augmented reality.

Street Views, such as those implemented in Google Maps, provide a navigable first person view of a given location, showing roads, outdoor areas, and the outside appearance of buildings.

A number of technologies are now adopting Indoor Views which provides the same capabilities as Street View for the inside of a building. A user can navigate inside a building, for example to explore the decor of a restaurant. Sites such as Google Business Street View and Indoor Street View offer the capability to photograph the inside of commercial buildings and embed this virtual tour into Google Maps. This has surfaced in Google Maps as the “See Inside” feature.

Other enterprises such as hotels, real estate agents, and vacation rentals have long offered similar virtual tour capabilities of their properties. These Indoor View virtual tours are typically siloed—some may be found by visiting a mapping tool such as Google Maps, some by visiting a hotel web site, and some by visiting the property listing of a real estate agent. There is currently no easy way to view an Indoor View of a location just by looking at a sign that advertises the location.

Accordingly, there is a need in the art for an automated method for displaying the indoor view of a building by simply viewing it.

### SUMMARY

The disclosure is directed to inventive methods and systems for automatically displaying an indoor view of a building when the building is viewed by a user wearing augmented reality glasses. The system uses contextual data captured by a camera mounted on the augmented reality glasses to identify the building in view and automatically retrieve an indoor view of the building. The contextual data may be a logo or a sign near a building. In an embodiment, the contextual data is used to obtain the name of the location or business which, in conjunction with the geolocation data of the augmented reality glasses, is submitted to a search engine. In an embodiment, the results of the search engine are used to identify a relevant repository of indoor views and to retrieve from the repository at least one indoor view of the building identified by the sign or logo. According to an embodiment, the indoor view may be overlaid over or adjacent to the building.

According to an aspect, a method for displaying an indoor view of a building includes the steps of: capturing, with a camera coupled to a pair of augmented reality glasses, at least one image; identifying, within the image, an identifying marker; determining from the identifying marker a search parameter; obtaining the geolocation of the glasses or a mobile device paired with the glasses; entering the search parameter into a search engine; receiving from the search engine the location of at least one building; selecting the building having the location nearest to the geolocation of the glasses or the mobile device; retrieving from an indoor view repository an indoor view of the selected building; displaying at least a portion of the retrieved indoor view over a portion of the user's field of view when wearing the glasses.

According to an embodiment, the identifying marker is a logo.

According to an embodiment, the method further includes the steps of identifying, with a search engine, the name of the business associated with the identifying marker, wherein the name of the business defines at least part of the search parameter.

According to an embodiment, the identifying marker is text.

According to an embodiment, the method further includes the steps of selecting the indoor view repository from a plurality of indoor view repositories, according to the identifying marker.

According to an embodiment, the step of displaying includes the steps of: displaying a portion of the retrieved indoor over a first floor of the selected building, the selected portion representing the first floor; and displaying a second portion of the retrieved indoor view over a second floor of the selected building, the second portion representing the second floor.

According to an embodiment, at least a second portion of the retrieved indoor view may be displayed upon receiving a command from a user.

According to an embodiment, the search parameter is a name of a business.

According to an embodiment, the portion of the retrieved view is displayed adjacent to the identifying marker.

According to an aspect, a mobile device having a non-transitory storage medium, defining program code, is programmed to perform the steps of: receiving from a pair of augmented reality glasses at least one image; identifying, within the image, an identifying marker; determining from the identifying marker a search parameter; obtaining the geolocation of the glasses or a mobile device paired with the glasses; entering the search parameter into a search engine; receiving from the search engine the location of at least one building; selecting the building having the location nearest to the geolocation of the glasses or the mobile device; transmitting to the glasses at least a portion of the retrieved indoor view.

According to an embodiment, the mobile device is further programmed to identify, with a search engine, the name of the business associated with the identifying marker, wherein the name of the business defines at least part of the search parameter.

According to an embodiment, the mobile device is further programmed to select the indoor view repository from a plurality of indoor view repositories, according to the identifying marker.

According to an embodiment, the mobile device is further programmed to: transmit to the glasses a portion of the retrieved indoor view representing a first floor of the selected building; and transmit to the glasses a second portion of the retrieved indoor view representing a second floor of the selected building.

According to an embodiment, the mobile device is further programmed to transmit a second portion of the retrieved indoor view upon receiving a command from a user.

According to an aspect, a system for displaying an indoor view of a building includes: a database having a plurality of indoor views; an augmented reality viewer; and a mobile device comprising a processor, where the mobile device is in communication with the augmented reality viewer and the database; and where the processor is configured to obtain, using a geolocation of the augmented reality viewer or the mobile device, a location of a building having a location nearest to the geolocation of the augmented reality viewer or the mobile device, and is further configured to retrieving from the database an indoor view of the building and display at least a portion of the retrieved indoor view on the augmented reality viewer.

According to an embodiment, the augmented reality viewer includes a camera configured to capture an image, and the processor is configured to use an identifying marker in the captured image to obtain the location of the building

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the invention.

FIG. 1 is a schematic representation a system for automatically retrieving an indoor view of a building, in accordance with an embodiment.

FIG. 2 is a flow chart of a method for automatically retrieving an indoor view of a building, according to an embodiment.

FIG. 3 is a flow chart for identifying a building, in accordance with an embodiment.

FIG. 4A is an image of a sign bearing at least one identifying marker, in accordance with an embodiment.

FIG. 4B is an image of a sign bearing at least one identifying market, in accordance with an embodiment.

FIG. 5A is an image of a sign having at least one overlaid thumbnail image, in accordance with an embodiment.

FIG. 5B is an image of a sign having at least one overlaid thumbnail image, in accordance with an embodiment.

FIG. 6 is an image of a sign bearing at least one identifying marker, in accordance with an embodiment.

### DETAILED DESCRIPTION

The present disclosure is directed to inventive methods and systems for automatically displaying an indoor view of a building when the building is viewed by a user wearing augmented reality glasses. The system uses contextual data captured by a camera mounted on the augmented reality glasses to identify the building in view and automatically retrieve an indoor view of the building. The contextual data may be a logo or a sign near a building. In an embodiment, the contextual data is used to obtain the name of the location or business which, in conjunction with the geolocation data of the augmented reality glasses, is submitted to a search engine. In an embodiment, the results of the search engine are used to identify a relevant repository of indoor views and to retrieve from the repository at least one indoor view of the building identified by the sign or logo. According to an embodiment, the indoor view may be overlaid over or adjacent to the building.

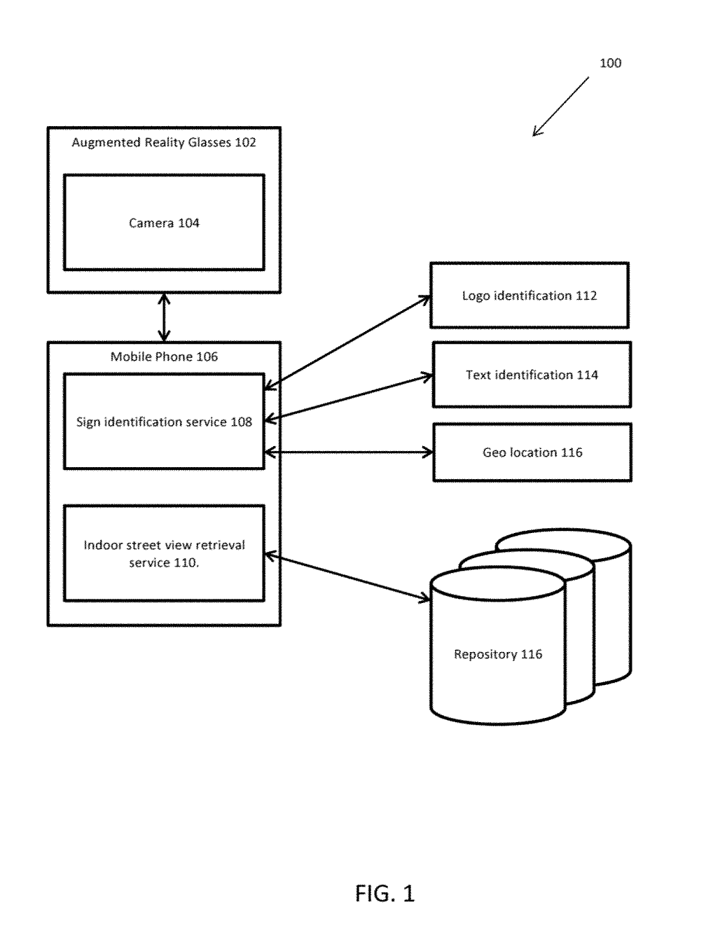

Referring to FIG. 1, according to an embodiment there is shown a system 100 for retrieving an indoor view of a location from contextual data retrieved by a mobile device. System 100 may include a pair of augmented reality glasses 102 that is configured to capture a user's environment, using a camera 104, and to overlay information about the user's environment over at least a portion of the user's field of view. In an embodiment, the overlaid information may be a thumbnail view 504 of an indoor view of a building located in the user's environment, as will be described in detail below. In an embodiment, augmented reality glasses 102 may contain a processor and primary and/or secondary memory sufficient for storing and executing program code. In an embodiment, augmented reality glasses 102 may be further equipped with a communications interface for pairing and communicating with a mobile device. Furthermore, augmented reality glasses 102 may include a display or projector for overlaying an image over a portion of the user's field of view.

Augmented reality glasses 102 may further include gesture control to allow a user to identify objects in the environment, and/or may be configured to receive commands from a user via a sensor or button or soft button located on augment reality glasses 102 or located on a separate device. For example, augmented reality glasses may include a sensor or small button located on the earpiece of the glasses that is configured to receive commands from the user. Using the gesture control or other input, augmented reality glasses may be configured to allow a user to the select the thumbnail view 504 of the indoor view in order to see the full indoor view.

Augmented reality glasses 102 may be further paired with a mobile device 106 (or, alternately any other device capable of performing the functions outlined below) that is capable of receiving and analyzing image data captured by camera 104 and retrieving indoor view data for displaying in the user's field of view. More specifically mobile device 106 may contain program code stored on a non-transitory storage medium that broadly defines two services: context identification service 108 and indoor view retrieval service 110.

Context identification service 108 is broadly configured to receive and process the image data received from augmented reality glasses 102, so that the proper indoor views may be later retrieved. Context identification service 108 may use at least three methods of determining the user's location and the surrounding structures. First, sign identification service 108 may analyze the image captured from the augmented reality glasses to determine the owner of at least one logo captured by augmented reality glasses 102. An external service, logo identification 112, accessed remotely, may be employed to aid in the identification of any logos captured by augmented reality glasses 102. In addition, text identification 114, another external service, may be employed to determine the content of text located on a structure or sign captured by augmented reality glasses 102. Finally, geo location 116 may be employed to determine the location of the user. Geo location 116 may use a variety of means to determine the location of the mobile device, such as GPS, or it may triangulate the location of the user from nearby cell towers. Using the location of the user and the logos and text on any signage, sign identification determines the business or location portrayed in the sign.

Indoor view retrieval service 110 uses the identified location to query the relevant repository, such as google maps, or realty websites, and retrieve the appropriate indoor view. Upon receiving the indoor view, mobile device 106 may deliver a thumbnail 504 image of the indoor view to be displayed by augmented reality glasses 102. Alternatively, or upon receiving a command, mobile device 106 may deliver the indoor view retrieved from the repository to the augmented reality glasses 102.

It should understood that, although augmented reality glasses 102 has been described to be paired with a mobile device 106, it should be understood that, in an alternate embodiment, augmented reality glasses 102 may perform all processing on its own processor such that it may perform the functions performed by sign identification service 108 and indoor view retrieval service 110 without the use of mobile device 106. Alternately, mobile device 106 may use its own camera (not shown), to capture the environment data and to display the augmented view on its own view, including the thumbnail 504 image and indoor view. In this way, mobile device 106 may perform the functions described above without using augmented reality glasses 102.

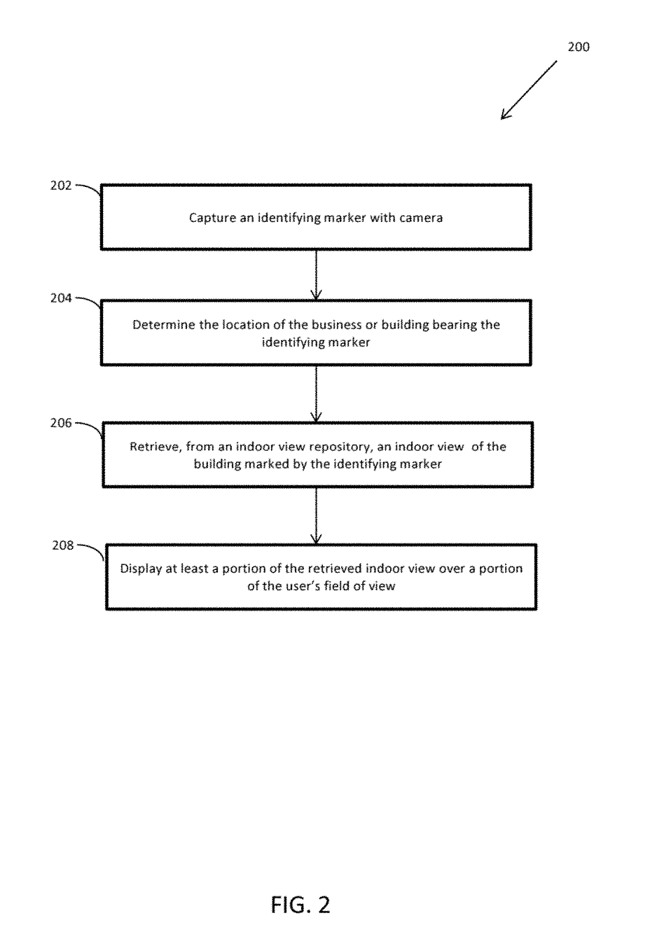

Referring to FIG. 2, there is shown a flow chart of a method 200 for retrieving an indoor view of a location from contextual data retrieved by a mobile device. The method utilizes one or more embodiments of the systems described or otherwise envisioned herein. For example, method 200 may use system 100 described above, including augmented reality glasses 102 and mobile device 106. Alternately, the method may be wholly performed by augmented reality glasses 102 or by mobile device 106.

At step 210 of the method, an identifying marker 502 is captured using a camera 104 installed on the augment reality glasses 102. Examples of such signs include real estate “for sale” signs, logos for shopping centers, etc. Where multiple signs or logos are in view, the user may select which sign to focus on, or augmented reality glasses 102 may capture every sign in view, processing each according to the steps outlined below.

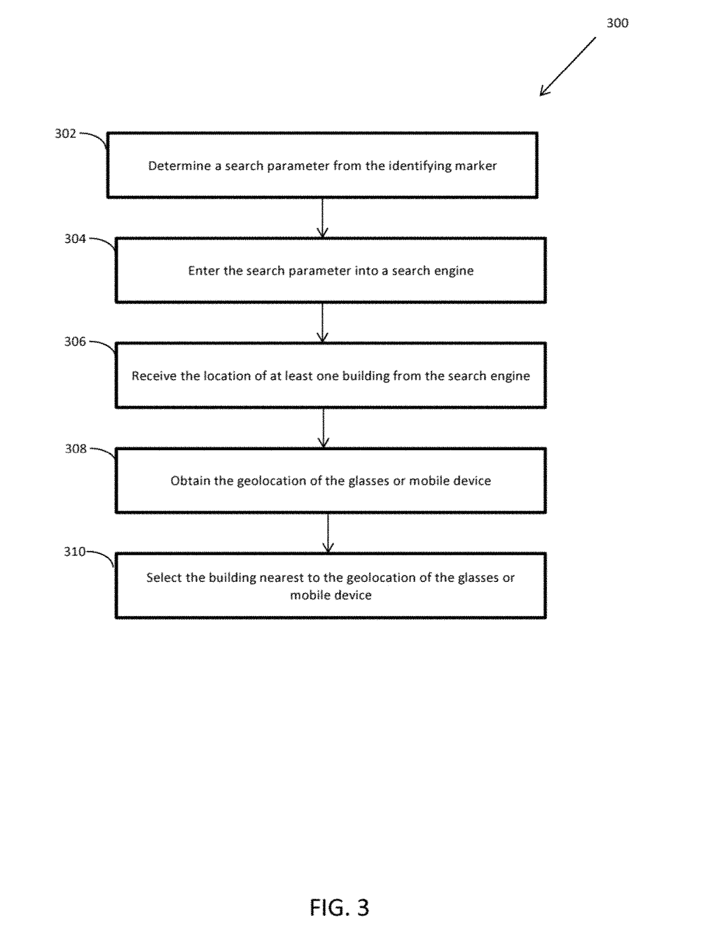

At step 212, the captured image of the sign(s) is sent to a mobile device 106 to determine the location of the business or building represented by the captured image. Image processing may, in an embodiment, include identifying, using logos or text of the captured image and the location of the mobile device, the business or building marked by the captured sign or logo. This process is described in greater depth in FIG. 3.

At step 214, the indoor view of the identified business or building is retrieved from at least one repository. This step may further include the steps of retrieving the indoor view from Google maps (by using, for example, an API), or generating a query to retrieve the view from a realty website or other websites which store indoor views that may be accessed via web searches.

For example, with the name and address of the location identified, indoor view retrieval service 110 may search for an indoor view of the location in the appropriate repository. For commercial properties, this includes the indoor view feature of Google Maps. For listed properties and vacation rentals, the Virtual Tours from the appropriate realtor/vacation rentals web site may also be searched.

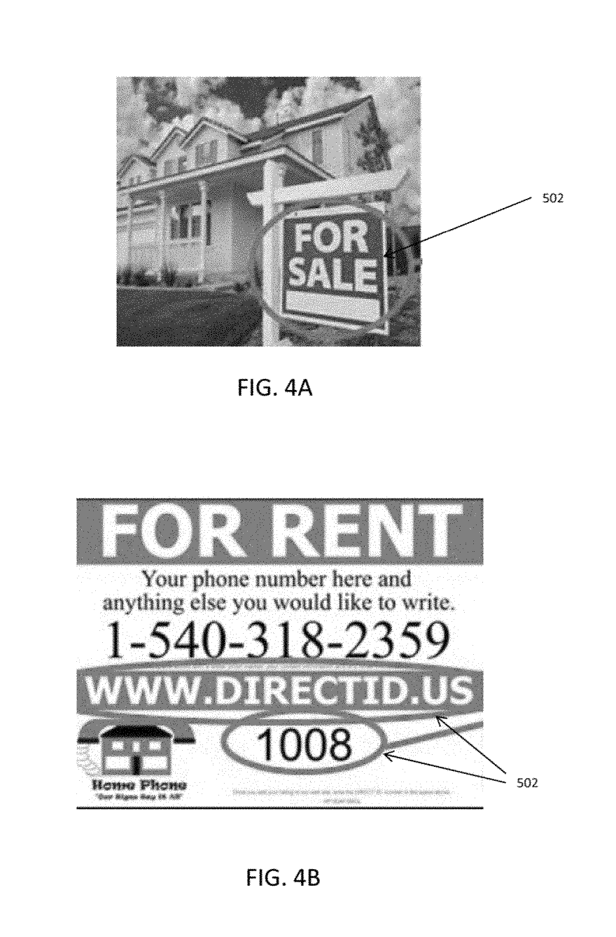

However, in some cases, an additional repository must be searched to determine the name and address of the location in the sign. FIGS. 4A and 4B show examples of a property with a For Sale sign and a property with a For Rent sign, respectively. In FIG. 4B, the sign shows the web address of the rental agency and the rental ID of the property. A search can be made using this web address to determine the name and address of the location. The second example, in FIG. 4A, shows no property information other than that the property is for sale. In this instance the geo-location of the augmented reality glasses 102 is used to search the appropriate repository for properties for sale within this geolocation (in this case, the sign indicates the sale of a private home so a real estate repository such as realtor.com may be searched).

At step 218, the augmented reality glasses 102 may display a thumbnail 504 of the view over the business or sign that was captured. Further, when selected by a user, the augmented reality glasses 102 may begin to display the indoor view as a larger view, or augment reality classes 102 may show other points within the building upon receiving a command from the user. It should be understood that the augmented reality glasses 102 may display any portion of the retrieved view as a thumbnail 504.

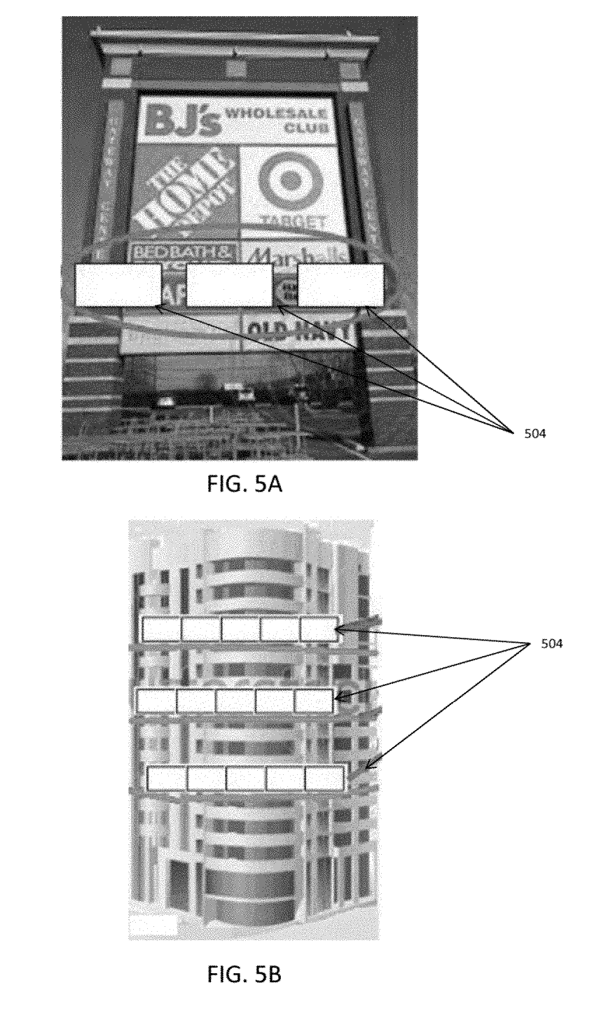

As shown in FIG. 5A, the thumbnail view 504 may be positioned over the identifying marker 502, adjacent to the identifying marker 502, or over a point of the building corresponding to the location of the retrieved indoor view. For example, if the indoor view corresponds to a particular floor of a building, the thumbnail view 504 may be placed over that floor of the building. Where there are multiple floors, as shown in FIG. 5B, each having a retrieved indoor view, the thumbnail 504 may be placed over the respective associated floor.

Referring now to FIG. 3 there is shown a method 300 for identifying the location of the business or building associated with the identifying marker 502.

At step 302, a search parameter may be determined from the identifying marker 502. The search parameter may be any text or phrase that, when inputted into a search engine such as Google, would be helpful for identifying the building bearing the identifying marker 502.

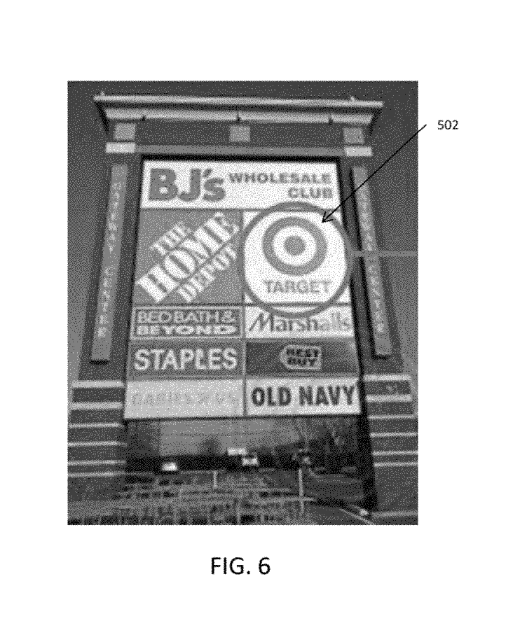

For example, if the identifying marker 502 is a logo, image analysis may be used identify the presence of a logo in the image. When a potential logo is identified, this portion of the image may be sent to a logo identification service, such as Google Goggles, or it may be compared against another local or remote database of known logos. If the logo's associated business is identified, the name of the associated business may be retrieved and used as a part of the search parameter. For example, the sign for a shopping center may contain logos of the commercials stores in the shopping center. Examples of these signs may be shown in FIG. 6.

In another example, if the identifying marker 502 is text, the content of the text may be identified. This may be accomplished using an external service or through processing on the mobile device. Any identified text may spell out the name or location of the business or building, which may then be used as at least part of the search parameter. Alternately, this may indicate what the sign is advertising (i.e. For Sale, For Rent) and the agency involved in the sale.

At step 304, the search parameter obtained from the identifying marker 502 may be input into a search engine in order to identify the building bearing the identifying marker 502. For example Google or any other search engine may be queried using the search parameter. Alternately, the identifying marker 502 itself may be used to identify the proper search engine. For example, if the identifying marker 502 bears text such as a “For Sale” sign or a “For Rent” sign, the website of the realtor or rental agency may serve as the search engine. The name of the rental proper, other text on the identifying marker 502, or the location of the identifying marker 502 may form the search parameter for the rental or realtor web site. Alternately, if a “For Sale” sign is identified, a realty web site that compiles listings from a multitude of realtors may be used as the search engine.

At step 306, the search engine may return a plurality of locations according to the search parameters. For example, if Target is the search parameter, the search engine may return a list of Target stores. If the location is the search parameter, the buildings near to that location may be returned. If the search parameter is unique enough, it is possible that only a single building will be returned.

At step 308, the geo location of the augmented reality glasses 102 or the mobile device 106 may be obtained. Again, a variety of means may be used to determine the location of the mobile device, such as GPS. Alternately, the location of the mobile device 106 or augmented reality glasses 102 may be triangulated from nearby cell towers.

At step 310, of buildings returned by the search engine in step 306, the building nearest to the geolocation determined in step 308, is selected. For example, if several Target stores were returned in step 306, the Target store nearest to the obtained geolocation may be selected. Note, that in alternate embodiments, the geolocation may be obtained prior to step 304 may be used as a search parameter itself or as way to limit the results of the search engine.

For example, through textual recognition, the name of the store may be determined to be “Target,” the logo also matches the store “Target” and the shopping center name is “Gateway Center.” This information is combined with the geo-location of the augmented reality glasses 102 or mobile device 106 which is approximately the same as the geo-location of the sign in the field of view. A search for stores named “Target” within the geo-location coordinates is made. This search returns the closest match: there are Target stores within 0.2 miles and 9.8 miles of this location. It can be determined with probability that this sign relates to the Target store within 0.2 miles.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

1. A method for displaying an indoor view of a building, comprising the steps of:
capturing, with a camera coupled to a pair of augmented reality glasses, at least one image;
identifying, within the image, an identifying marker;
determining, from the identifying marker, a search parameter;
obtaining the geolocation of the glasses or a mobile device paired with the glasses;
entering the search parameter into a search engine;
receiving from the search engine the location of at least one building;
selecting the building having the location nearest to the geolocation of the glasses or the mobile device;
retrieving from an indoor view repository an indoor view of the selected building; and
displaying at least a portion of the retrieved indoor view over a portion of the user's field of view when wearing the glasses.

2. The method of claim 1, wherein the identifying marker is a logo.

3. The method of claim 1, further comprising the step of identifying, with a search engine, a name of the business associated with the identifying marker, wherein the name of the business defines at least part of the search parameter.

4. The method of claim 1, wherein the identifying marker is text.

5. The method of claim 1, further comprising the step of selecting the indoor view repository from a plurality of indoor view repositories.

6. The method of claim 1, wherein the step of displaying comprises the steps of:
displaying a portion of the retrieved indoor over a first floor of the selected building, the selected portion representing the first floor; and
displaying a second portion of the retrieved indoor view over a second floor of the selected building, the second portion representing the second floor.

7. The method of claim 1, wherein at least a second portion of the retrieved indoor view may be displayed upon receiving a command from a user.

8. The method of claim 1, wherein the search parameter is a name of a business.

9. The method of claim 1, wherein the portion of the retrieved view is displayed adjacent to the identifying marker.

10. A mobile device comprising a computer readable storage medium having program instructions embodied therewith, wherein the computer readable storage medium is not a transitory signal per se, the program instructions executable by the mobile device to cause the mobile device to perform a method comprising:
receiving from a pair of augmented reality glasses at least one image;
identifying, within the image, an identifying marker;
determining from the identifying marker a search parameter;
obtaining the geolocation of the glasses or a mobile device paired with the glasses;
entering the search parameter into a search engine;
receiving from the search engine the location of at least one building;
selecting the building having the location nearest to the geolocation of the glasses or the mobile device;
retrieving from an indoor view repository an indoor view of the selected building; and
transmitting to the glasses at least a portion of the retrieved indoor view.

11. The mobile device of claim 10, wherein the identifying marker is a logo.

12. The mobile device of claim 10, the method further comprising identifying, with a search engine, the name of the business associated with the identifying marker, wherein the name of the business defines at least part of the search parameter.

13. The mobile device of claim 10, wherein the identifying marker is text.

14. The mobile device of claim 13, the method further comprising selecting the indoor view repository from a plurality of indoor view repositories, according to the identifying marker.

15. The mobile device of claim 10, the method further comprising:
transmitting to the glasses a portion of the retrieved indoor view representing a first floor of the selected building; and
transmitting to the glasses a second portion of the retrieved indoor view representing a second floor of the selected building.

16. The mobile device of claim 10, the method further comprising transmitting a second portion of the retrieved indoor view upon receiving a command from a user.

17. The mobile device of claim 10, wherein the search parameter is the name of a business.

18. The mobile device of claim 10, wherein the geolocation is obtained using a geolocation service of the mobile device.

19. A system for displaying an indoor view of a building, the system comprising:
a database comprising a plurality of indoor views;
an augmented reality viewer; and
a mobile device comprising a processor, wherein the mobile device is in communication with the augmented reality viewer and the database;
wherein the processor is configured to obtain, using a geolocation of the augmented reality viewer or the mobile device, a location of a building having a location nearest to the geolocation of the augmented reality viewer or the mobile device, and is further configured to retrieve from the database an indoor view of the building and display at least a portion of the retrieved indoor view on the augmented reality viewer.

20. The system of claim 19, wherein the augmented reality viewer comprises a camera configured to capture an image, and wherein the processor is further configured to use an identifying marker in the captured image to obtain the location of the building.
